(19) United States
(12) Patent Application Publication
(10) Pub. No.: US 2023/0231151 A1
(43) Pub. Date: Jul. 20, 2023

(54) LAYER SYSTEM, BIPOLAR PLATE COMPRISING SUCH A LAYER SYSTEM, AND FUEL CELL PRODUCED THEREWITH

(71) Applicant: Schaeffler Technologies AG & Co. KG, Herzogenaurach (DE)

(72) Inventors: Moritz WEGENER, Erlangen (DE); Jeevanthi VIVEKANANTHAN, Herzogenaurach (DE); Yashar MUSAYEV, Nürnberg (DE); Ladislaus DOBRENIZKI, Höchstadt (DE); Detlev REPENNING, Reinbeck (DE)

(73) Assignee: Schaeffler Technologies AG & Co. KG, Herzogenaurach (DE)

(21) Appl. No.: 17/601,175

(22) PCT Filed: Feb. 21, 2020
(86) PCT No.: PCT/DE2020/100126

§ 371 Date: Oct. 4, 2021

(30) Foreign Application Priority Data
Apr. 3, 2019 (DE) 10 2019 108 660.4

(51) Int. Cl. H01M 8/0236; H01M 8/0258; H01M 8/1018; H01M 8/1004; C25B 11/032; C25B 11/036; C25B 11/069

(52) U.S. Cl. CPC H01M 8/0236; H01M 8/0258; H01M 8/1018; H01M 8/1004; C25B 11/032; C25B 11/036; C25B 11/069; H01M 2008/1095

(57) ABSTRACT

A layer system (1) for coating a bipolar plate (2), including at least one cover layer (1a) made of tin oxide, wherein at least one metal oxide of the group comprising tantalum oxide, niobium oxide, titanium oxide, zirconium oxide, and hafnium oxide is homogenously dissolved in the tin oxide, and the electric conductivity of the cover layer (1a) is greater than or equal to 10² S/cm. A bipolar plate (2, 2′) is also provided with an anode side and a cathode side, comprising a substrate (2a, 2a′) and such a layer system (1), and to a fuel cell (10) or an electrolyzer comprising such a bipolar plate (2, 2′).

### CROSS-REFERENCE TO RELATED APPLICATIONS

This application is the U.S. National Phase of PCT Appln. No. PCT/DE2020/100126, filed Feb. 21, 2020, which claims priority to DE 102019108660.4, filed Apr. 3, 2019, the entire disclosures of which are incorporated by reference herein.

### TECHNICAL FIELD

The disclosure relates to a layer system for coating a bipolar plate, comprising at least one cover layer made of tin oxide. The disclosure further relates to a bipolar plate comprising a metallic substrate and such a layer system. The disclosure further relates to a fuel cell comprising at least one such bipolar plate.

### BACKGROUND

A bipolar plate arrangement for a fuel cell unit is already known from DE 10 2008 036 849 A1, in which a coating on the cathode side is formed by a tin oxide doped with fluorine.

WO 03/092 139 A2 discloses a fuel cell with one or more bipolar plates which are coated with a corrosion-resistant metal and furthermore with an electrically conductive, polycrystalline tin oxide layer. The tin oxide layer can be fluorine-doped or antimony-doped. The corrosion-resistant metal is either a nickel alloy or is selected from the group of the metals tantalum, niobium, zirconium and hafnium.

DE 10 2008 055 808 A1 describes a bipolar plate for a fuel cell which has a hydrophilic coating, the hydrophilic layer being formed by a metal oxide or a carbide. Silicon dioxide, hafnium dioxide, zirconium dioxide, aluminum oxide, tin oxide, tantalum pentoxide, niobium pentoxide, molybdenum dioxide, iridium dioxide, ruthenium dioxide and mixtures thereof are described as suitable metal oxides. To increase the electrical conductivity, it is described that the metal oxide can be doped, among other things, with N, C, Li, Ba, Pb, Mo, Ag, Au, Ru, Re, Nd, Y, Mn, V, Cr, Sb, Ni, W, Zr, Hf or mixtures thereof. Chromium carbide, titanium carbide, tantalum carbide, niobium carbide and zirconium carbide are mentioned as carbides suitable for forming a hydrophilic layer.

### SUMMARY

It is the object of the disclosure to provide an improved layer system for a bipolar plate and to provide such a bipolar plate. Another object of the disclosure is to propose a fuel cell having at least one such bipolar plate.

The object is achieved for the layer system for coating a bipolar plate, comprising at least one cover layer made of tin oxide, in that at least one metal oxide of the group comprising tantalum oxide, niobium oxide, titanium oxide, zirconium oxide and hafnium oxide is homogenously dissolved in the tin oxide, and wherein the electric conductivity of the cover layer is greater than or equal to 10² S/cm. The layer system is characterized by high long-term stability combined with simultaneously high electrical conductivity and low costs. In addition, the layer system ensures excellent corrosion protection for a metallic base material or substrate of a bipolar plate.

The layer system is preferably made by a PVD or a CVD process (PVD: physical vapor deposition; CVD: chemical vapor deposition).

The cover layer in particular has a layer thickness in the range from 0.1 to 15 μm, in particular in the range from 0.5 to 3 μm.

Cover layers which have a metal oxide in the form of tantalum oxide and/or niobium oxide in homogeneous solution in tin dioxide are particularly preferred here. The above-mentioned advantages are achieved here based on a mixed phase that forms in the form of alpha-tin dioxide-tantalum oxide and/or alpha-tin dioxide-niobium oxide.

In particular, the cover layer in the homogeneous solution of tin oxide and metal oxide has a proportion of 0.1 to 5 at % tantalum and/or niobium and/or titanium and/or zirconium and/or hafnium. The electrical conductivity of the formed mixed phase has a maximum in this range.

It is particularly preferable if the cover layer is doped with iridium and/or ruthenium. The iridium and/or the ruthenium is preferably present in the cover layer in a concentration in the range from 10⁻⁴ at % to 0.1 at %. This increases the electrical conductivity of the cover layer even further.

In a preferred embodiment of the layer system, an adhesive layer is also present in addition to the cover layer, the adhesive layer having a layer thickness in the range from 1 nm to 300 nm. The adhesive layer is preferably formed containing at least one element from the group comprising titanium, tantalum, niobium, zirconium and hafnium. The purpose of the adhesive layer is to improve the adhesion of the cover layer to the base material or substrate of a bipolar plate.

Preferably, between the cover layer and the adhesive layer, there is arranged:

at least one intermediate layer of a metal carbide or

at least one intermediate layer of a metal nitride or

at least one intermediate layer of a metal boride or

at least one intermediate layer comprising
at least one metal carbide and at least one metal nitride or
at least one metal carbide and at least one metal boride or
at least one metal nitride and at least one metal boride or
at least one metal carbide and at least one metal nitride and at least one metal boride or

a combination of two or more such intermediate layers.

The intermediate layer should in particular ensure adhesion between the adhesive layer and the cover layer.

In particular, the metal carbide and/or the metal nitride and/or the metal boride has at least one metal from the group comprising titanium, tantalum, niobium, zirconium and hafnium. The at least one metal is preferably present in a concentration in the range from 30 to 56 at % in the metal carbide and/or metal nitride and/or metal boride.

Of these hard materials, the metal borides have the highest electrical conductivity. It is therefore advantageous if the at least one intermediate layer contains boron. The boron serves here to increase conductivity and thus in particular to adjust the electrical conductivity of the intermediate layer(s).

A layer thickness of an individual intermediate layer is preferably selected in the range from 0.1 to 0.5 μm. However, there can be two or more intermediate layers.

In a particularly preferred embodiment of the layer system, the cover layer is doped with fluorine. This leads to a stabilization and further hydrophobization of the cover layer and significantly increases the long-term stability of the layer system. Thus, it cannot only be advantageously used on a cathode side of a bipolar plate, i.e. under anodic oxidation conditions, but can also be used on an anode side of the bipolar plate, since the formation of superficial hydroxide composites is prevented, which would have a negative, i.e. increasing, influence on a surface resistance of the cover layer. A doping of the cover layer with fluorine in the range from 0.5 to 5 at % has proven useful.

In order to further increase the electrical conductivity of the cover layer, it has proven to be advantageous if the cover layer is further doped with nitrogen and/or carbon. A doping of the cover layer with nitrogen in the range from 0 to 10 at % and/or with carbon in the range from 0 to 10 at % has proven useful.

The layer system according to the disclosure, comprising the adhesive layer, at least one intermediate layer and the cover layer, preferably has a total thickness in the range from 0.1 to 20 μm.

In particular, the following layer systems have proven to be advantageous for coating a metallic bipolar plate, in particular one made of austenitic steel:

### EXAMPLE 1

Adhesive layer: --

Intermediate layer: --

Cover layer: SnO₂—0.95 at % Ta₂O₅

### EXAMPLE 2

Adhesive layer: Niobium

Intermediate layer: --

Cover layer: SnO₂—1.3 at % Nb₂O₅

### EXAMPLE 3

Adhesive layer: Tantalum

Intermediate layer: Tantalum carbide

Cover layer: SnO₂₋ₓFₓ—0.95 at % Ta₂O₅
doped with 1 at % Ir (Ir content per cm²: 0.27 μg; per kW: 180 μg)

### EXAMPLE 4

Adhesive layer: Niobium

Intermediate layer: Niobium nitride

Cover layer: SnO₂₋ₓN_{y}F_{z}—1.3 at % Nb₂O₅
with z=0.05; y=0.3; x=z+y=0.35

### EXAMPLE 5

Adhesive layer: TiNb

Intermediate layer: Titanium niobium nitride

Cover layer: SnO₂₋ₓFₓ—0.2 at % Ta₂O₅—1 at % Nb₂O₅
with x=0.1

The object is achieved for a bipolar plate with an anode side and a cathode side, comprising a substrate and a layer system according to the disclosure, having a structure of the bipolar plate in the following order:

substrate

gas diffusion layer,

optional adhesive layer,

optional intermediate layer(s),

cover layer.

This is preferably a bipolar plate with a metallic substrate or a metallic carrier plate, in particular made of austenitic stainless steel. A carrier plate can be designed in one or more parts. The layer system is preferably arranged on the cathode side of the bipolar plate, but can also be used on the anode side of the bipolar plate with appropriate fluorination and optionally further doping with nitrogen and/or carbon.

The object is also achieved for a fuel cell or an electrolyzer, wherein this is designed to include at least one bipolar plate according to the disclosure. The fuel cell is designed in particular as an oxygen-hydrogen or air-hydrogen fuel cell. It has proven useful if the fuel cell comprises at least one polymer electrolyte membrane.

Table 1 below shows a comparison of different cover layers of the layer system according to the disclosure.

TABLE 1
Comparison of cover layers of different compositions

| | | | | | Contact |
|---|---|---|---|---|---|
| | | | | | resistance |
| | | | Contact | | according |
| | | | resistance | Surface | to CV |
| | | Layer | in mΩcm² | energy | up to |
| | | thickness | at | in | 2000 mV* |
| # | Cover layer | d in nm | T = 20° C. | mN/m | in mΩcm² |
| 1 | SnO₂- | 250-350 | 11 | 75 | 16 |
| | 0.95 at % Ta₂O₅ | | | | |
| 2 | SnO₂- | 250-300 | 14 | 85 | 22 |
| | 1.3 at % Nb₂O₅ | | | | |
| 3 | SnO₂₋ₓFₓ- | 250-350 | 10 | 35 | 11 |
| | 0.95 at % Ta₂O₅ | | | | |
| 4 | SnO₂Fₓ- | 250-350 | 9.5 | 36 | 10 |
| | 1.3 at % Nb₂O₅ | | | | |
| 5 | SnO₂₋ₓC_{y}F_{z}- | 250-350 | 8.3 | 32 | 8.5 |
| | 1.3 at % Nb₂O₅ | | | | |
| | (z + y = x) | | | | |
| 6 | SnO₂₋ₓ C_{y} F_{z}- | 250-300 | 8.5 | 31 | 8.5 |
| | 0.95 at % Ta₂O₅ | | | | |
| | (z + y = x) | | | | |
| 7 | SnO₂₋ₓN_{y}F_{z}- | 250-300 | 9.4 | 34 | 9.9 |
| | 1.3 at % Nb₂O₅ | | | | |
| | (z + y = x) | | | | |
| 8 | SnO₂₋ₓN_{y}F_{z}- | 250-300/1 | 6.5 | 40 | 6.4 |
| | 0.95 at % Nb₂O₅ | | | | |
| | (z + y = x) + Ir-C | | | | |
| 9 | SnO₂₋ₓN_{y}F_{z}- | 250-300/1 | 7.2 | 46 | 7.8 |
| | 0.95 at % Nb₂O₅ | | | | |
| | (z + y = x) + Ir45-Ru55 | | | | |
| 10 | SnO₂₋ₓFₓ- | 300 | 10 | 35 | 10.5 |
| | 0.95 at % Ta₂O₅- | | | | |
| | 0.1 at % Ir* | | | | |
| 11 | SnO₂₋ₓFₓ- | 300 | 7 | 38 | 6.8 |
| | 0.95 at %Ta₂O₅-1 | | | | |
| | at % Ir** | | | | |

* Ir content per cm²: 0.027 μm per kW: 18 μg
**lr content per cm²: 0.27 μg per kW: 180 μg

0<x≤0.65; 0<y≤0.5; 0<z≤0.15

### BRIEF DESCRIPTION OF THE DRAWINGS

FIGS. 1 to 5 are intended to explain, by way of example, a layer system according to the disclosure and a bipolar plate coated therewith and a fuel cell. In the figures:

FIG. 1 shows a bipolar plate having the layer system

FIG. 2 schematically shows a fuel cell system comprising a plurality of fuel cells

FIG. 3 shows a section III-III through the arrangement according to FIG. 1

FIG. 4 shows a section through two bipolar plates and a polymer electrolyte membrane according to FIG. 2 arranged therebetween; an

FIG. 5 shows a cross-section through a layer system in an enlarged illustration.

### DETAILED DESCRIPTION

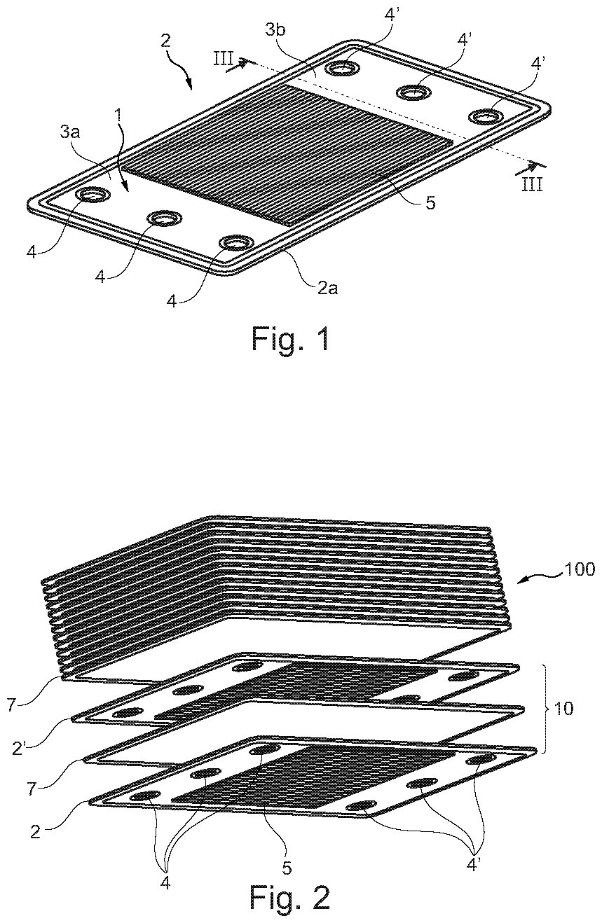

FIG. 1 shows a bipolar plate 2 with a layer system 1, which here has a metallic substrate or a metallic carrier plate 2a made of stainless steel. The layer system 1 covers the bipolar plate 2 at least on its cathode side. The layer system 1 has a total thickness in the range of 100 nm to 20 μm. The bipolar plate 2 has an inflow area 3a with openings 4 and an outlet area 3b with further openings 4′ which are used to supply a fuel cell with process gases and to remove reaction products from the fuel cell. The bipolar plate 2 also has a gas distribution structure 5 on each side, which is provided for contact with a polymer electrolyte membrane 7 (see FIG. 2).

FIG. 2 schematically shows a fuel cell system 100 comprising a plurality of fuel cells 10. Each fuel cell 10 comprises a polymer electrolyte membrane 7 which is adjacent to both sides of bipolar plates 2, 2′. The same reference symbols as in FIG. 1 indicate identical elements.

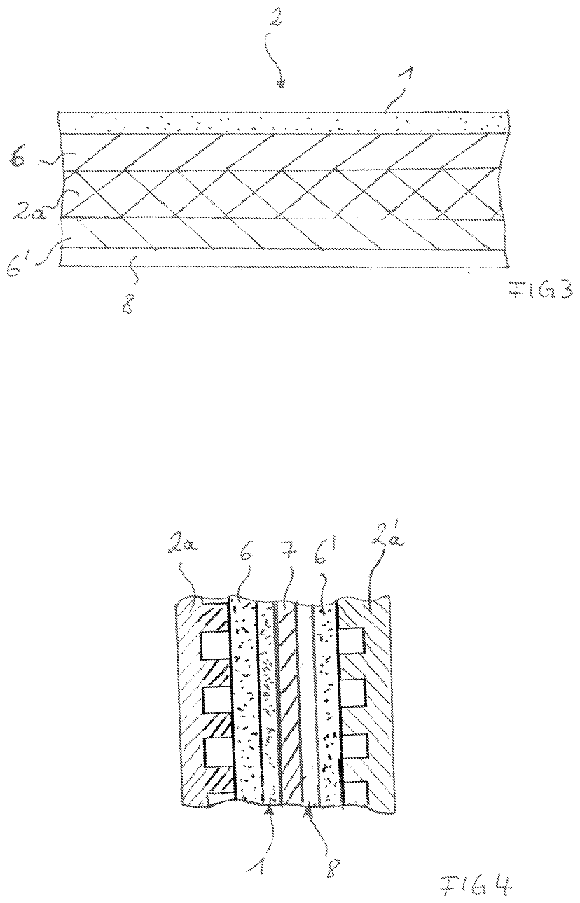

FIG. 3 shows a section III-III through the bipolar plate 2 according to FIG. 1. The same reference symbols as in FIG. 1 indicate identical elements. The carrier plate 2a, which is formed here from stainless steel, can be seen, which can be constructed in one part or in several parts. A gas diffusion layer 6 is arranged between the carrier plate 2a and the layer system 1. It can also be seen that a further anode-side coating 8 of the carrier plate 2a is provided. This can correspond to the layer system 1. Alternatively, a coating 8 can be provided which is designed according to DE 10 2016 202 372 A1. A further gas diffusion coating 6′ is located between the coating 8 and the carrier plate 2a. The gas diffusion coatings 6, 6′ are designed to be electrically conductive, and in particular are made of a fiber mat made of carbon material.

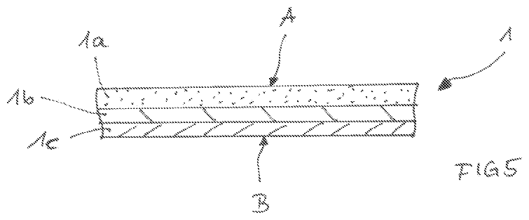

FIG. 4 shows a section through two bipolar plates 2, 2′ and a polymer electrolyte membrane 7 according to FIG. 2 arranged therebetween, which together form a fuel cell 10. The same reference symbols as in FIGS. 1 and 3 indicate identical elements. It can be seen that the layer system 1 of a first bipolar plate with carrier plate 2a as the cathode, and the coating 8 of a second bipolar plate with a further carrier plate 2a′ as the anode, are arranged adjacent to the polymer electrolyte membrane 7. The gas diffusion layers 6, 6′ can also be seen.

FIG. 5 shows a cross-section through the layer system 1 according to FIG. 1. It can be seen that a cover layer 1a, an intermediate layer 1b and an adhesive layer 1c are present. The adhesive layer 1c is located on a side B of the layer system 1 which is arranged facing the carrier plate 2a of the bipolar plate 2. The cover layer 1a is located on a side A of the layer system 1 which is arranged facing away from the carrier plate 2a of a bipolar plate 2. Alternatively, the layer system 1 can also have a plurality of intermediate layers 1b.

### LIST OF REFERENCE SYMBOLS

1 Layer system

1a Cover layer

1b Intermediate layer(s)

1c Adhesive layer

2, 2′ Bipolar plate

2a, 2a′ Metallic substrate; carrier plate

3a Inflow area

3b Outlet area

4, 4′ Opening

5 Gas distribution structure

6, 6′ Gas diffusion coating

7 Polymer electrolyte membrane

8 Coating

10 Fuel cell

100 Fuel cell system

A Side of the layer system 1 facing away from the carrier plate 2a

B Side of the layer system 1 facing the carrier plate 2a

1. A layer system (1) for coating a bipolar plate (2), comprising at least one cover layer (1a) made of tin oxide, characterized in that at least one metal oxide of the group comprising tantalum oxide, niobium oxide, titanium oxide, zirconium oxide and hafnium oxide is homogeneously dissolved in the tin oxide, and in that the electric conductivity of the cover layer (1a) is greater than or equal to 10² S/cm.

2. The layer system (1) according to claim 1, characterized in that the cover layer (1a) is doped with iridium and/or ruthenium.

3. The layer system (1) according to claim 2, characterized in that the iridium and/or the ruthenium is present in the cover layer (1a) in a concentration in the range from 10⁻⁴ at % to 0.1 at %.

4. The layer system (1) according to one of the preceding claims, characterized in that an adhesive layer (1c) is also present in addition to the cover layer (1a), the adhesive layer (1c) having a layer thickness in the range from 1 nm to 300 nm.

5. The layer system (1) according to claim 4, characterized in that the adhesive layer (1c) is formed containing at least one element from the group comprising titanium, tantalum, niobium, zirconium and hafnium.

6. The layer system (1) according to claim 4 or 5, characterized in that between the cover layer (1a) and the adhesive layer (1c) there is arranged
at least one intermediate layer (1b) of a metal carbide or
at least one intermediate layer (1b) of a metal nitride or
at least one intermediate layer (1b) of a metal boride or
at least one intermediate layer (1b) comprising
at least one metal carbide and at least one metal nitride or
at least one metal carbide and at least one metal boride or
at least one metal nitride and at least one metal boride or
at least one metal carbide and at least one metal nitride and at least one metal boride or
a combination of two or more such intermediate layers (1b).

7. The layer system (1) according to claim 6, characterized in that the metal carbide and/or the metal nitride and/or the metal boride has at least one metal from the group comprising titanium, tantalum, niobium, zirconium and hafnium.

8. The layer system (1) according to claim 7, characterized in that the at least one metal is present in a concentration in the range from 30 to 56 at % in the metal carbide and/or metal nitride and/or metal boride.

9. The layer system (1) according to one of claims 6 to 8, characterized in that the at least one intermediate layer (1b) contains boron.

10. The layer system (1) according to one of claims 1 to 9, characterized in that the cover layer (1a) is doped with fluorine.

11. The layer system (1) according to claim 10, characterized in that the cover layer (1a) is further doped with nitrogen and/or carbon.

12. A bipolar plate (2, 2′) having an anode side and a cathode side, comprising a substrate (2a, 2a′) and a layer system (1) according to one of claims 1 to 11, having a structure of the bipolar plate in the following order:
substrate, in particular metallic substrate (2a, 2a′),
gas diffusion layer (6, 6′),
optional adhesive layer (1c),
optional intermediate layer(s) (1b),
cover layer (1a).

13. A fuel cell (10), in particular an oxygen-hydrogen fuel cell, or electrolyzer, comprising at least one bipolar plate (2, 2′) according to claim 12.

14. The fuel cell (10) according to claim 13, comprising at least one polymer electrolyte membrane (7).
